(19) United States
(12) Patent Application Publication
(10) Pub. No.: US 2021/0248146 A1
(43) Pub. Date: Aug. 12, 2021

(54) Pipeline Data Processing

(71) Applicant: Arm IP Limited, Cambridge (GB)

(72) Inventor: John Ronald Fry, Campbell, CA (US)

(73) Assignee: Arm IP Limited, Cambridge (GB)

(21) Appl. No.: 17/252,853

(22) PCT Filed: Jun. 17, 2019
(86) PCT No.: PCT/GB2019/051678

§ 371 Date: Dec. 16, 2020

Related U.S. Application Data
(60) Provisional application No. 62/686,423, filed on Jun. 18, 2018.
(60) Provisional application No. 62/686,431, filed on Jun. 18, 2018.
(60) Provisional application No. 62/686,439, filed on Jun. 18, 2018.
(60) Provisional application No. 62/686,445, filed on Jun. 18, 2018.

(30) Foreign Application Priority Data
Jul. 31, 2018 (GB) 1812431.3
Jul. 31, 2018 (GB) 1812432.1
Jul. 31, 2018 (GB) 1812433.9
Jul. 31, 2018 (GB) 1812435.4

(51) Int. Cl. G06F 16/2455; G06F 16/25; G06F 16/2457; G06F 11/30

(52) U.S. Cl. CPC G06F 16/24568; G06F 11/3068; G06F 16/24573; G06F 16/258

(57) ABSTRACT

A machine implemented method of data processing in a data stream pipeline is provided. The data stream pipeline is formed from multiple sources of input data, and the method comprises: receiving input data from multiple sources, the data having differing format and data rates; buffering the data and transforming the data to a predetermined format; pre-processing the transformed data to create one or more output data streams, each in a respective canonical format; outputting the formatted output data stream to any data driven application and analytic platform; gathering behavioural data relating to at least one of: received input data, the receiving of the input data, the transformations applied to the input data, pre-processing of the transformed data, the output data streams, and the consumption of the output data streams; and using the gathered behavioural data to generate a signal.

The present technology relates to methods and apparatus for the processing of pipeline data in a system configured to perform consumption driven data contextualization. In particular, a data digest system operates by means of data gathering, data analytics and value-based exchange of data.

As the computing art has advanced, and as processing power, memory and the like resources have become commoditised and capable of being incorporated into objects used in everyday living, there has arisen what is known as the Internet of Things (IoT). Many of the devices that are used in daily life for purposes connected with, for example, transport, home life, shopping and exercising are now capable of incorporating some form of data collection, processing, storage and production in ways that could not have been imagined in the early days of computing, or even quite recently. Well-known examples of such devices in the consumer space include wearable fitness tracking devices, automobile monitoring and control systems, refrigerators that can scan product codes of food products and store date and freshness information to suggest buying priorities by means of text messages to mobile (cellular) telephones, and the like. In industry and commerce, instrumentation of processes, premises, and machinery has likewise advanced apace. In the spheres of healthcare, medical research and lifestyle improvement, advances in implantable devices, remote monitoring and diagnostics and the like technologies are proving transformative, and their potential is only beginning to be tapped.

In an environment replete with these IoT devices, there is an abundance of data which is available for processing by analytical systems enriched with artificial intelligence, machine learning and analytical discovery techniques to produce valuable insights, provided that the data can be appropriately digested and prepared for the application of analytical tools.

Difficulties abound in this field, particularly when data is sourced from a multiplicity of incompatible devices and over a multiplicity of incompatible communications channels. It would, in such cases, be desirable to virtualise data sources to enable any application to retrieve and manipulate data without requiring technical information about the data such as how the data is formatted, where it is located, how it is delivered across a network, and how it can be consumed by an application, such as a data analysis tool, to produce usable information.

Such gathered data may be processed for the technical purposes of, for example, gathering security analytics to initiate a security response, understanding data patterns for network optimisation, determining data flow for load balancing across nodes of a network, tracking data consumption to improve data digest speeds and analysing data usage so that a value based exchange of data between endpoints can be negotiated to an agreed standard.

In a first approach to some of the many difficulties encountered in appropriately gathering data in a data digest system, the presently disclosed technology provides a machine implemented method of data processing in a data stream pipeline, wherein the data stream pipeline is formed from multiple sources of input data, the method comprising: receiving input data from multiple sources, the data having differing format and data rates; buffering the data and transforming the data to a predetermined format; pre-processing the transformed data to create one or more output data streams, each in a respective canonical format; outputting the formatted output data stream to any data driven application and analytic platform; gathering behavioural data relating to at least one of: received input data, the receiving of the input data, the transformations applied to the input data, pre-processing of the transformed data, the output data streams, and the consumption of the output data streams; and using the gathered behavioural data to generate a signal.

In a hardware approach, there is provided electronic apparatus comprising logic components operable to implement the methods of the present technology. In another approach, the computer-implemented method may be realised in the form of a computer program product.

Implementations of the disclosed technology will now be described, by way of example only, with reference to the accompanying drawings, in which:

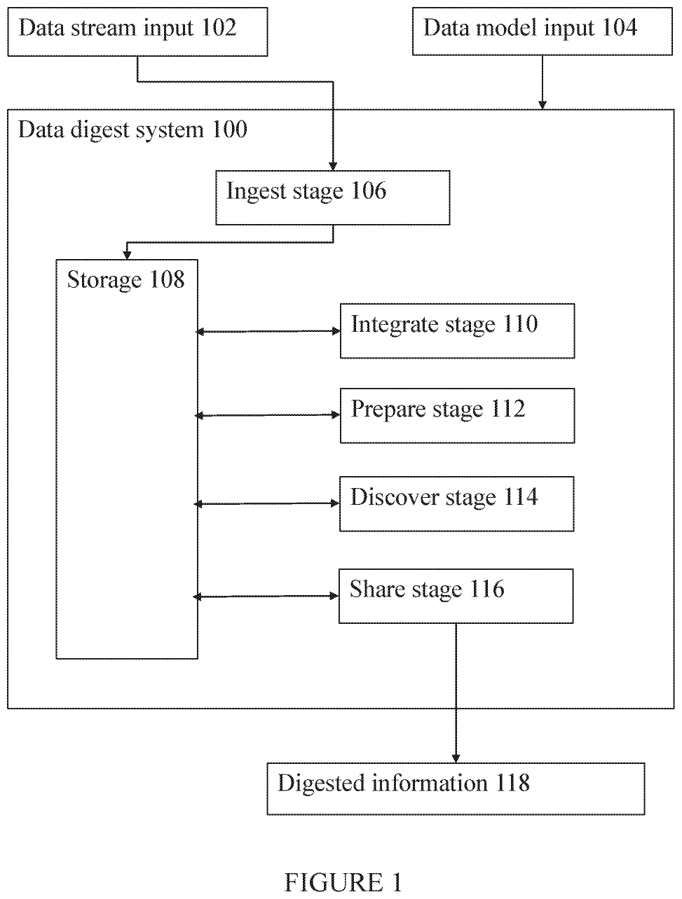

FIG. 1 shows a block diagram of an arrangement of logic, firmware or software components comprising a data digest system in which the presently described technology may be implemented;

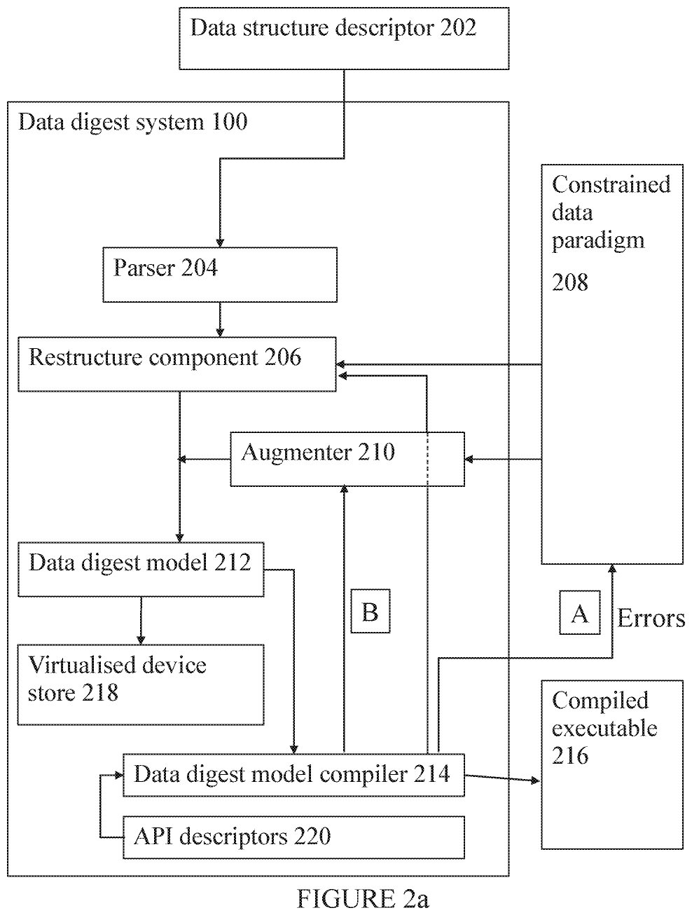

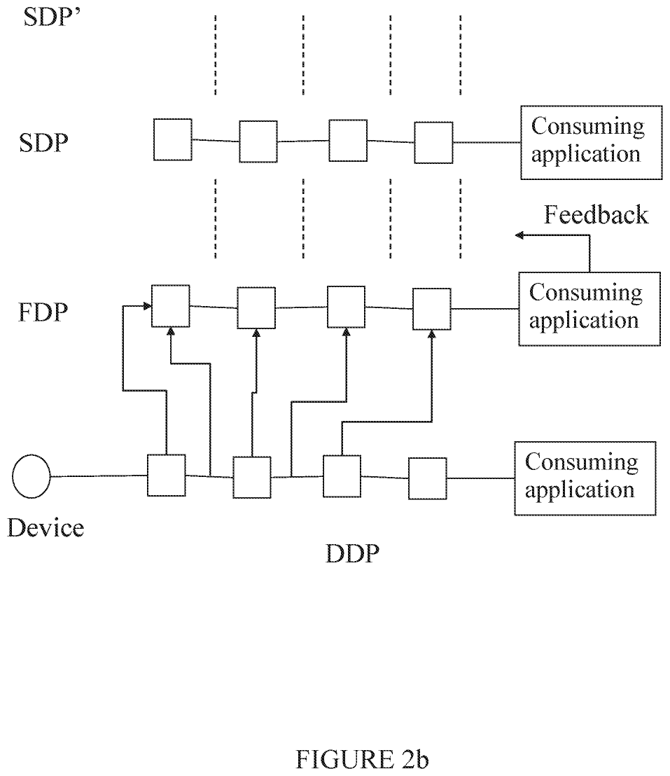

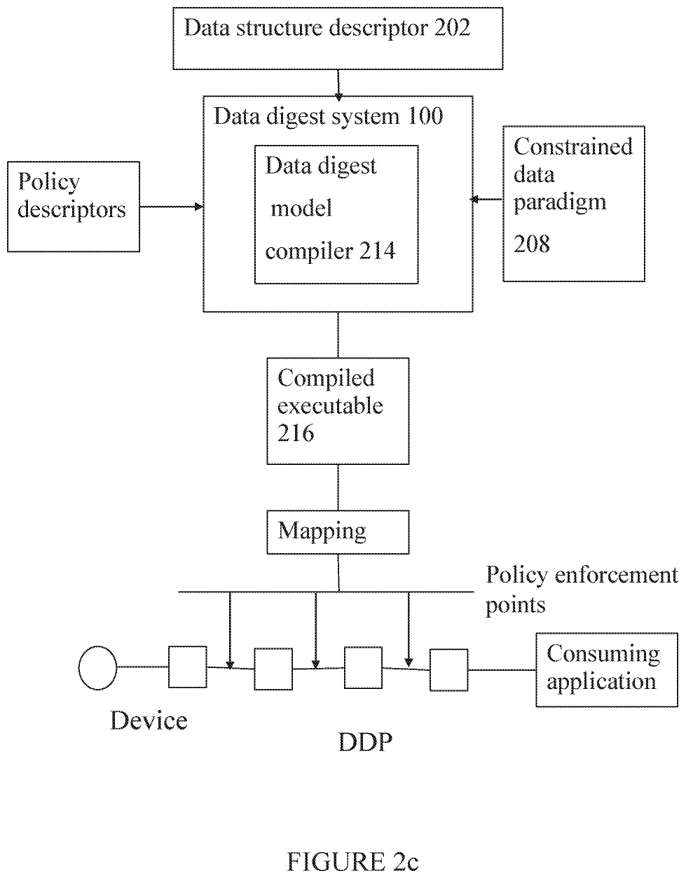

FIG. 2a shows an example of an arrangement of logic, firmware or software components incorporating a compilable data model according to an implementation of the presently described technology;

FIGS. 2b and 2c illustrate additional details of the arrangement according to FIG. 2a;

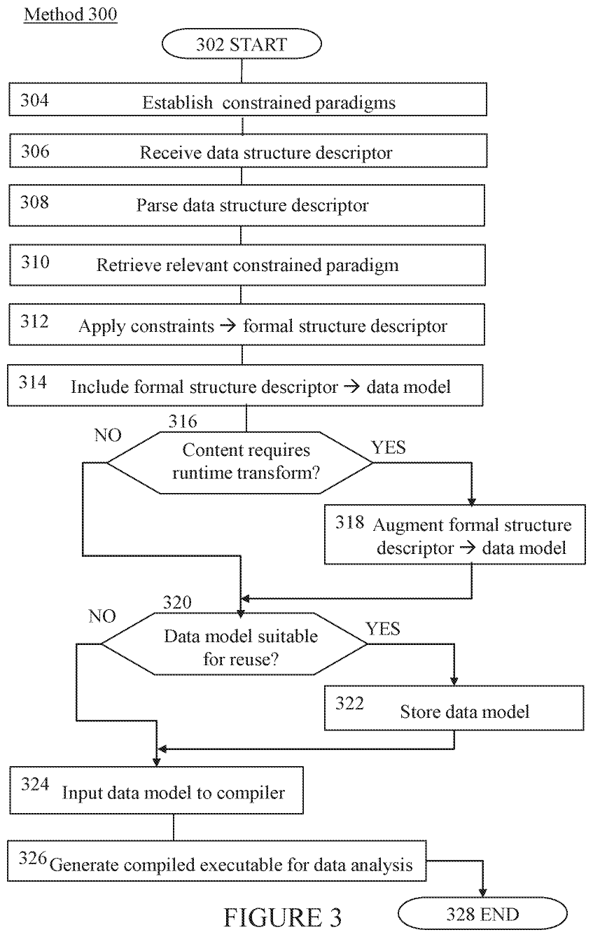

FIG. 3 shows one example of a computer-implemented method according to an implementation of the presently described data digest technology;

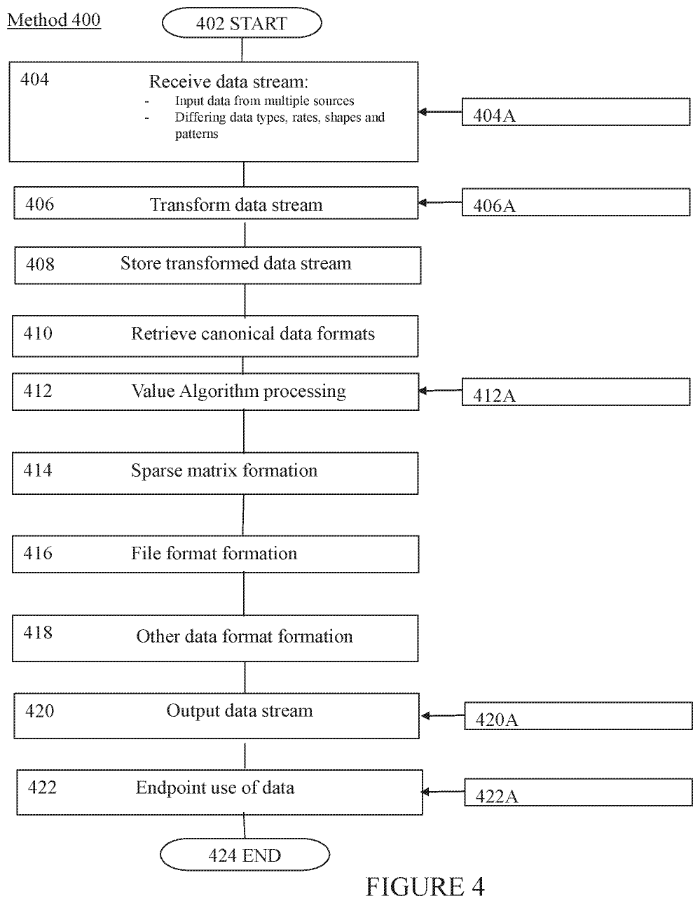

FIG. 4 shows a further example of a computer-implemented method according to an implementation of the presently described data digest technology;

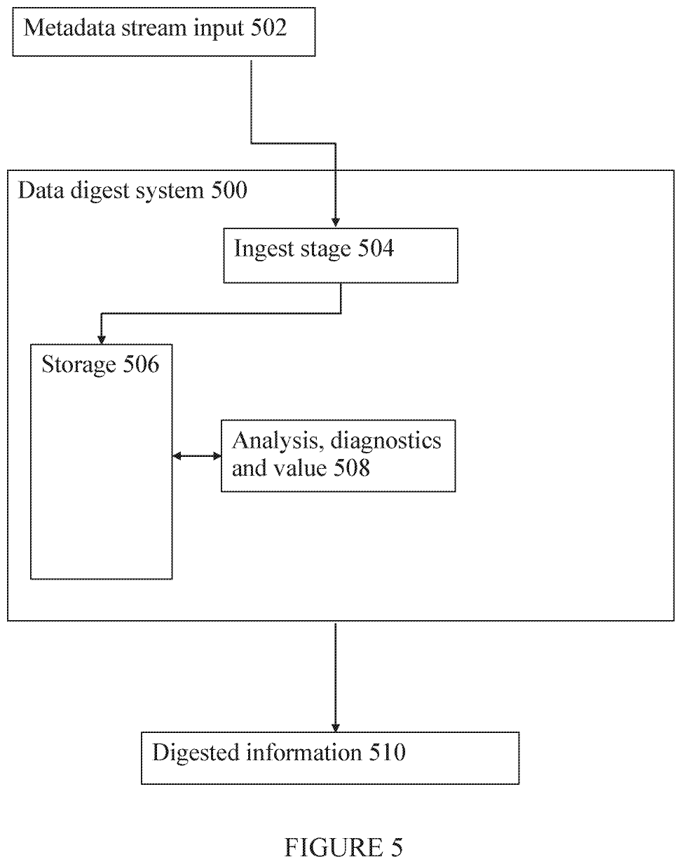

FIG. 5 shows a further example of an arrangement of logic, firmware or software components according to an implementation of the presently described data digest technology;

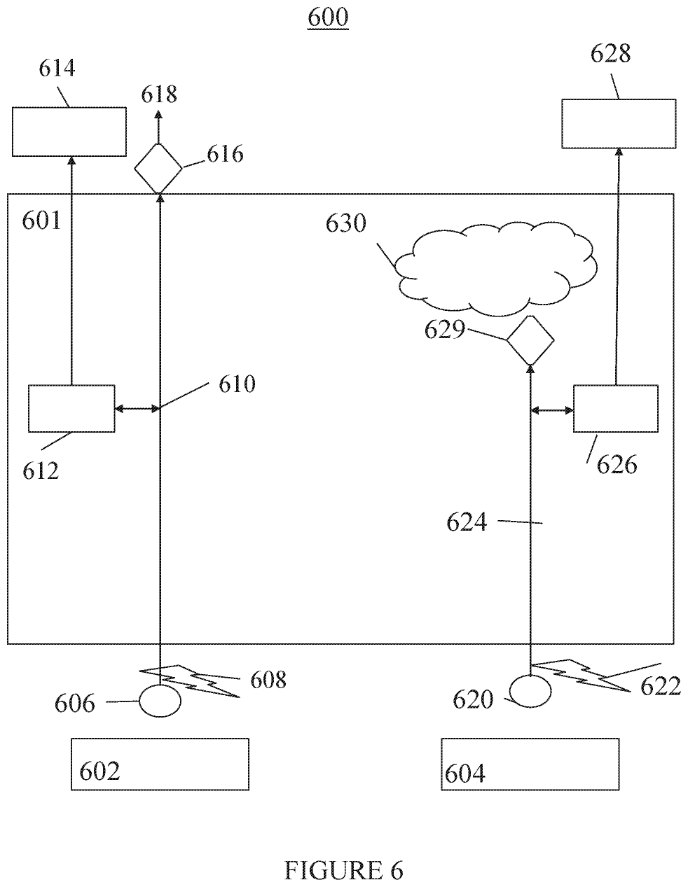

FIG. 6 shows a further example of an arrangement of logic, firmware or software components according to an implementation of the presently described data digest technology; and

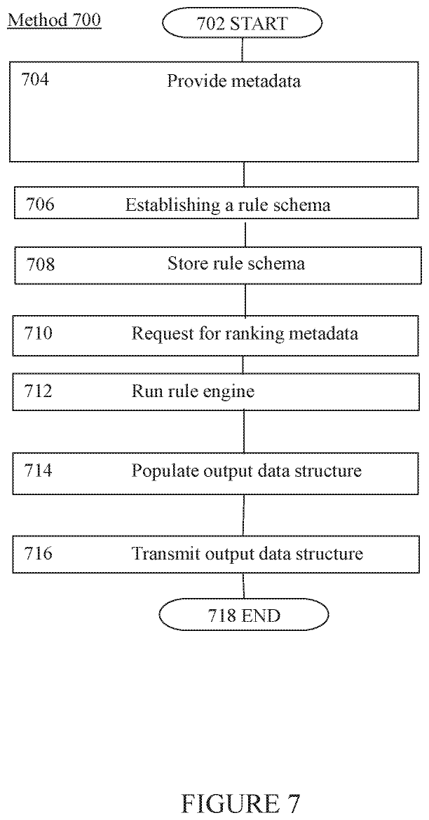

FIG. 7 shows a further example of a computer-implemented method according to an implementation of the presently described data digest technology.

The present technology thus provides computer-implemented techniques and logic apparatus for providing data processing that enables data to be sourced and gathered from large numbers of heterogeneous devices and made available in forms suitable for processing by many different analysis and learning systems without requiring users to understand the technicalities of the data digest processing pipeline from the data source to the consuming data analysis tool. At the same time, the desideratum of flexibility to allow more sophisticated data processing of the data pipeline can be accommodated by permitting extraction of metadata at different developmental stage points in the data digest pipeline, so that data may be analysed for use in applications and reused to configure pipelines tailored to meet more advanced needs.

The present technology is operable as part of a data digest service that can ingest data from a wide range of source devices, process it into one or more internal representations and then enable access to the data to one or more subscribers wishing to access the content. Such value based exchange of data between endpoints can take the form of a negotiated agreement on a machine to machine basis, machine to user basis or between users. The present technology is driven, not by the built-in constraints of the data source devices, but by the needs of the consuming application, thus making each data source behave as if it was specifically tuned to the needs of the consuming application. This enables the possibility that one single device can take on many different data delivery configurations without the need to reconfigure the device itself, and this in turn forms the basis of IoT device data sharing.

Existing data analysis systems for capturing and handling streamed data, such as data from IoT data source devices, are typically producer-specific and thus limited to producing constrained data structures, handling data from specific products or nodes as it was formatted by those products and nodes, and using tailored analysis solutions—these data analysis systems are thus not adaptable and do not scale or integrate well in systems having consumers needing different data for different purposes, provided by a variety of different devices from different manufacturers with different data rates, different communications bandwidths and different types and formats of content. The present technology addresses at least some of the difficulties inherent in developing the necessary systems and platforms to analyse data in the IOT data space with its massive proliferation of data source devices. It achieves this by providing technologies to enable device data to be monitored and analysed without directly interacting with the physical devices or their raw data streams, thereby enabling a more efficient, scalable and reusable system for accessing the data provided by large numbers of heterogeneous data source nodes to a variety of differently-configured data consumer applications. This is implemented by, in effect, decoupling the data sources from the data streams they generate such that subscribers (typically software applications that consume the data) to the data subscribe to virtualized data streams, rather than to the data sources themselves. By decoupling the data source device from the consumer or subscriber, computational resources can be inserted and applied to the device streams such that device that is delivering data appears to be specifically designed to meet the exact needs of the consumer or subscriber application.

In one implementation, for example, a combination of inputs can connect to any source or destination. Deep learning systems may prefer vector forms and so data once transformed into a neutral format can be processed into a vector form suitable for deep learning systems. In this way, multiple canonical contracts may be formed between input and output sources.

In other implementations, the data stream is monitored and output to determine data usage analytics and applications. This additional data digest that extracts and logs behaviours at various stages of the data digest may use algorithms to determine usage. The extraction is a hierarchical extraction with each stage in the extraction drilling down further into the metadata and generating multiple levels of data digest. The metadata produced in this way are converted into sets of technical parameters and constraints that configure the entire data digest pipeline ready for runtime treatment of data streams received from data source devices. Such vertical extraction of data may be driven down to different points of the data pipeline to extract metadata, which metadata forms the basis for any algorithm that has a canonical relationship with the algorithm.

In brief, then, it is possible to extract metadata from the main data flow pipeline and this metadata is in turn processed in a new pipeline at a next level in a hierarchy.

Thus, at any stage of a data digest pipeline, a metadata tap into the various stages of the data digest pipeline can be created. These metadata taps are functions that can extract all the types of possible metadata (as described hereinbelow). Metadata tap functions can be stored in a library and the consumer (whether a human user or an automated system) can selectively and dynamically apply taps to new or established data digest pipelines. All of these metadata taps once in place will themselves generate new data—single/static pieces of data such as details of the data protocols used in the pipeline under observation or live data such as instantaneous flow rates, detected factual data such as received-data-protocol!=expected-protocol or calculated/derived data such as mean flow rate with a standard deviation from the mean. All of this metadata can be handled by the hierarchical application of another data digest pipeline. Machine-learning (ML) driven applications or monitoring applications can then be attached to this metadata data digest pipeline to derive abstract behavioural descriptions, visualizations or reports/logs on how the subject digest pipeline is behaving. By doing this all sort of anomaly detection and security applications can be realized.

The basic process for establishment of a metadata pipeline is:
1. Create the main data digest pipeline, as described above (to handle, for example, pipelining data from a specific type of IoT device to a consuming application). This is the device data pipeline (DDP).
2. Select the types of available metadata taps of interest from a library of available taps and apply them to DDP.
   a. This selection of taps can be automatically checked against what is permissible from the information sets in data structure descriptors and constrained data paradigms as shown in FIG. 2a. at 202, 208.
   b. The application of metadata taps can be incorporated into constrained data paradigms 208 on creation of the DDP if needed, or taps can be applied dynamically once the DDP is established.
3. Return to step (1) to create a second data digest pipeline to handle the ingest and processing of the metadata created from the metadata taps using the method described hereinabove. In one example, this may be a flow digest pipeline (FDP) which extracts metadata, such as flow rates, relating to the flow of data in the main pipeline.

Modification of this FDP is simply an editing process whereby new taps may be created or existing taps may be deleted or modified. FDP is itself a compilable data digest pipeline and may itself have taps added using the FIG. 2a 208 constrained data paradigms to include one or more metadata tap descriptors).

In a real-world IoT system there will be likely many DDPs servicing many devices and many FDPs extracting metadata, and the results from applications attached to FDPs can be further grouped together and have metadata taps applied to create a view a system view→SDP. A business or operation will likely consist of many device systems and so SDPs themselves can be grouped and metadata tapped→SDP′. In this way, a hierarchy such as DDP→FDP→SDP→SDP′→ . . . SDP″″″ may be created where the highest level is a metadata behavioural description of a large scale IoT data digest system.

An exemplary hierarchy of data and metadata pipelines is illustrated in FIG. 2b.

As will be clear to one of skill in the art, if in the use of SDP′″ something changes it could mean that the whole hierarchy of FDP to SDP′″ needs to be rebuilt or modified dynamically. In another case, if a change is made to FDP to fix SDP SDP″ may break. As such the dependency graph of all metadata contributions that come from recursive use of steps 1, 2, 3 above needs to be captured on creation and for all subsequent modifications so that any attempts at changes that may impact the metadata hierarchy can be checked/tested before application. Thus, in parallel to steps 1, 2, 3 above, the corresponding dependency graphs needed to be created, logged and stored.

The metadata derived in this manner can be used to drive metadata-consuming applications—these applications can then generate results/actions/requests that can then be fed back to change the behaviour of established DDP, FDP, SDP flows (e.g. stop or modify a flow of data) or to request the creation of another metadata pipeline to give the application more required data to meet its needs. For example, an automated-machine-learning-driven application may request high resolution data or statistical derivatives of existing data in order to increase the accuracy of results to the application.

In other implementations, third parties may attach algorithms to the data digest to analyse the data and in some embodiments make predictions using machine learning. Such predictions may be gathering of data for future bandwidth usage and requirements and to model a situation not yet occurred in using a probabilistic analysis.

In other implementations, a user may not have its own IoT infrastructure yet may have thousands of interconnected devices in the field

operating as, for example, temperature sensors. Present techniques provide a complete data digest for harvesting data from the interconnected devices to monitor their data usage, power, on-off times and memory constraints. The user may implement proprietary algorithms to model the behaviour of the interconnected devices.

In FIG. 1, there is shown a much-simplified block diagram of an exemplary data digest system 100 comprising logic components, firmware components or software components by means of which the presently described technology may be implemented. Data digest system 100 is operable to receive data stream input 102, which may be, for example, a real-time data feed, and to produce digested information 118 suitably prepared for use in analytical processing. Data stream input 102 may, alternatively, comprise data that has been stored in some form of data storage and either streamed out later in the form of a live real-time data stream or it may be batched out and presented in the form of blocks of prepared virtualized device data.

Data digest system 100 comprises ingest stage 106 operable to receive input data, which it may pre-process, for example, to render the data suitable for storage in storage component 108 and for further processing, wherein storage 108 may be operable as a working store or scratchpad for intermediate data under investigation by other stages 110, 112, 114, 116. Storage 108 may comprise any of the presently known storage means, such as main system memory, disk storage or solid-state storage, and any future storage means that are suited to the storage and retrieval of digital or analogue data in any form. Data digest system 100 further comprises integrate stage 110, prepare stage 112, discover stage 114, and share stage 116. These stages may be operable in any order, and plural stages may be operable at the same time or iteratively in a more complex refinement process. It will be immediately clear to one of skill in the art that the order in which the stages are shown in the present drawing figure does not imply any sequence constraint.

Integrate stage 110 is operable to form combinations of data according to predetermined patterns or, in combination with discover stage 114, according to the application of computational pattern discovery techniques. Prepare stage 112 may comprise any of a number of data preparation steps, such as unit-of-measurement conversion, language translation of natural or other languages, averaging of values, alleviation of anomalies such as communication channel noise, interpolating or recreating missing data values and the like. Discover stage 114 may comprise steps of application of data pattern mining techniques, parameter sweeping, “slice-and-dice” analysis and many other techniques for revealing information of potential interest in the data under investigation. Share stage 116 may comprise steps of, for example, re-translating data from internal formats into product-specific formats for use by existing analysis tools, preparing accumulations, averages of data and other statistical representations of data, and structuring data into suitable transmission forms for sharing over networks of data analysis and utilization systems.

Data digest system 100 is operable to receive as input a data model 104, which is a compilable entity for compilation into a runtime executable that controls the processing of data from data stream input 102 to digested information 118 by configuring the processes and transformations to be applied from ingest stage 106 to share stage 116.

It will be clear to one of skill in the art that each user's system may comprise a single type of data source device or many different types of device (a system of systems), producing the data stream 102. For an example of a user system having many different devices, consider an energy distribution monitoring system that may use smart meters, energy storage level sensors, sensors in home appliances, HVAC and light consumption sensors, local energy generation sensors (e.g. monitoring solar unit outputs), and energy transmission health/reliability monitors on transformers and syncro-phasers. Another example could be an automotive system that is reading in data from multiple devices embedded in a car such as GPS, speed sensors, engine monitoring devices, driver and passenger monitors, and external environment and condition sensors. Yet another example could be that of a home appliance company that reads back device data from sensors embedded in all of their consumer products across multiple product lines where the data received from a wide array of device/sensors types describes how the consumer uses the products.

In all of the cases a single device type can be considered a device system in its own right and the multi-device examples are systems of device systems. For any given single-device-type system there will be a unique mix of ingest, store, prepare, integrate, discover, and share services as shown in FIG. 1. In multiple-device-type systems, the mix is more complex.

Given that each user will have different preferred ways of consuming device system data it is expected that no two configurations of data digest will likely be the same. Because of this, opportunities to easily initially optimize systems for efficiency will be rare. Furthermore, it is expected that a device data system will not be a static entity but will evolve over time as more and more consuming applications attach to use its data via increased use of data digest's main services, which increases the difficulty in initially building optimal device data digest systems.

In every device system, metadata (behavioral data about the device data itself) can be gathered from any point in the data digest pipeline. For example:
At the point of ingest:
   The rate at which data is arriving;
   The protocols used to deliver the data;
   Data model and data descriptors;
   Any meta-data that is available from the device network that is delivering the data e.g.:
      Device security info;
      Network configuration and routing and point of device access;
      Network transport layer security applied;
      Network reliability and delivery statistics.
At the storage stage:
   How much data is stored in total;
   Data retention, archiving and deletion, patterns;
   Ratio of data written to data retrieved/read;
   Types of encryption applied to the data;
   User access patterns and type/number of users with permissions to access the data.
At the integrate stage:
   What other sources of data are being retrieved and being integrated into the device stream;
   Any metadata that comes with the other data source (which could also be related to previous ingest, storage, integrate, prepare, etc. stages already derived as metadata).
At the prepare stage:
   Types of transforms being applied to the data (e.g. graphs to lists, or streams to batches);
   Types of protocol conversions applied (e.g. JSON to XML);
   Types of mathematical or statistical operations applied to the data (e.g. conversion to mean and standard deviation, or application of signal component analysis).
At the discover stage:
   List of queries and searches that touch and reveal the data; including any metadata that accompanies the query/search:
      Types of users and organizations that issue the query/search;
      Types of consuming applications or M2M protocols that issue the query/search;
   Frequency of activation of data discovery service.
At the share stage:
   The rate at which data is being dispatched and consumed;
   The number of different consuming applications, users or machine-to-machine endpoints consuming the data;
   The protocols used to deliver the data to each consumer;
   Data model and data descriptors used to deliver the data to each consumer;
   Any meta-data that is available from the device network that is delivering the data, e.g.:
      Device security info;
      Network configuration and routing and point of device access;
      Network transport layer security applied;
      Network reliability and delivery statistics.

The above-described data and metadata, along with the relationships between data and metadata entities and attributes, may be envisioned as a form of network. The network relationships thus include relationships between all of the metadata attributes extractable from the data digest pipeline stages, of which examples are listed above. These can be tapped off as raw data and the relationships between them discovered using machine learning or artificial intelligence (AI) tools and mathematical/statistical techniques for calculating correlation coefficients between sets of data such as cosine similarity or pointwise mutual information (as basic examples). These relationships between the various metadata form a semi-static graph view of the metadata (where nodes are metadata/data flows and sets and edges are calculated relationships). This graphical view of metadata can then be stored (perhaps in a separate graph database) and updated periodically based on the needs of the applications that are consuming this data—for example, by attaching another data digest pipeline on demand. If a metadata view is established for each part of a system (for example, and SDP as described earlier), then other ML techniques can be applied to compare the different graphs of network relationships at the SDP layer and to pass them up to the next higher layer, SDP′.

This graph/network data can be consumed like any other data in the system—by attaching applications such as visualization apps or ML/AI driven applications serviced by data digest pipelines. These applications can perform functions such as system monitoring (SDP . . . SDP″ level) for anomalous behavior or for learning, tracking and optimizing flows of device data (at an FDP level). Graph analytic techniques are well known in the data systems analysis art, and need no further explanation here. It is worth observing that a graph view rendered from metadata as described above is itself actually a hierarchical use of data digest in its own right in that it could easily be built from data digest components and methods. Equally, in other implementations, it could be a coarse grain function at the level of ingest, store, prepare, share etc.

Any or all of this data can feed the metadata input 502, and the full suite of data digest services and methods can be applied to this data to attach specific applications that can use the data to analyze and optimize the data delivery path of any given device system or system of systems, including the path of the data modelled by any given compilable data digest model. For example:
By applying analysis to the ingest and sharing metadata, a user could optimize the flow of data across the delivery networks in any of the device system examples on the basis that at certain times of the day more data is delivered or consumed than at other times in the day.
By applying analysis to the storage data to determine the optimal storage solution for a set of accrued device data e.g. either hot, cold, or archive storage.
By applying analysis to the integrate and ingest metadata to determine that a particular device type or device data model is most often integrated with a particular other data source and therefore could be integrated earlier and more efficiently in the system.
By applying analysis to the ingest, discover and sharing stages to build a picture of who and what is consuming the data most frequently and in what combination to reveal opportunities to tune and modify both upstream consuming systems and downstream device systems. This permits the establishment of a canonical relationship between the devices and consuming applications so that analysis of the collected metadata improves the efficiency of the data digest services in bridging between the device and the consuming application.
Any and all combinations of metadata can be used to build up machine learning models and derive statistical behavioral patterns that describe typical usage of a device system's data and any deviation from this typical usage can be considered as indicators of anomalous behavior—thus, anomalous behavior flags can be used to spot security threats and device system reliability issues.
Any and all combinations of metadata can be used as the basis of deriving value and utility metrics about the data and the data digest models that initially digested the data to inform decisions.

In general, many device systems will typically be created and deployed at sub-optimal performance and efficiency (relative to the full range of potential use cases and unforeseen data sharing and consuming modes of attachment to the data digest system). The use of metadata in the examples given can provide the basis to improve the end-to-end computing efficiency of the delivery networks and data digest services that complete a device system.

Turning now to FIG. 2a, there is shown an example of a data digest system 100 as described above, with an arrangement of logic, firmware or software components according to the presently described technology. Data digest system 100 is operable to receive as input a data structure descriptor 202, which represents the data structures and content that can be emitted by at least one physical data source—for example, an IoT sensor device, such as a weather station or a wear sensor in a mechanical object. Data structure 202 typically comprises data field names, data field lengths, data type definitions, data refresh rates, precision and frequency of measurements available, and the like. Parser 204 is operable to parse such data structure descriptors, a process that typically involves recognition of the input descriptor elements and the insertion of syntactic and semantic markers to render the grammar of the descriptor visible to a subsequent processing component. In the present case, the parsed data structure descriptor is provided to a restructure component 206, which is operable to apply the constraints from one or more constrained data paradigms 208 to the parsed data structure descriptor to generate a formal structure descriptor as part of compliable data digest model 212. The constrained data paradigm 208 may be created and controlled by a human operator or by a linked computing system, using machine-to-machine communication. Constrained data paradigms 208 will be described in further detail hereinbelow. Data digest model 212 is formed in compliance with the input requirements of data digest model compiler 214, so that data digest model compiler 214 can apply its compilation rules to generate compiled executables 216 constructed for use by many data analysis systems with differing requirements. During the generation of compilable data digest model 212, augmenter 210 is operable to apply further constraints from one or more constrained data paradigms 208 to the parsed data structure descriptor in cases where any data content defined in the parsed data structure descriptor will require runtime transformation before it can be processed by compiled executable 216. Augmenter 210 augments the formal structure descriptor with processing directives that are to be executed at runtime to transform the above-described data content. The processing directives that are operable to cause runtime transformation may comprise one or more computer processing instruction sequences in at least one computer program language, and may be provided in plural computer program languages for operability in plural computer environments. The augmented formal structure descriptor is incorporated in compilable data digest model 212 prior to its compilation by data digest model compiler 214 to generate compiled executable 216. In one possible implementation, compilable data digest model 212 may further be stored as a descriptor of a virtualised device in virtualised device store 218, thus making it available for reuse, modification and sharing in the future. The stored data digest model 212 may be used, for example, for near-match analysis of discovered physical data source devices. In one implementation, stored data digest model 212 may be modified to achieve one or more exact matches to be stored for reuse as input to the data digest model compiler to generate a further compiled executable operable to process data content from at least one such discovered physical data source device.

In one example, data and metadata may be defined to the data digest system in the form of a formal language representation, such as a JSON representation. In one implementation, the resulting model of data may be augmented to provide processing directives that will render the incoming data into a suitable format (such as a parameter list form) for consumption by the compiled executable. Such processing directives may be the result of explicit programming by programmers, or may be themselves generated by the compiler logic, as shown in FIG. 2a.

Normally, if the compiler fails for any reason to turn 202, 208 into an executable representation of a data digest pipeline then it will issue errors. These errors—via path A—can be reported to a user who can than act on them by modifying 208. This process may be repeated until the compiler succeeds. In a refinement, an extended compiler could also issue new processing directives and requests/information/suggestions, via path B of FIG. 2a, to try to restructure at 206 to help compiler 214 to succeed. This application of directives may in practice be a multi-pass process.

In one practical example, a processing directive may be required where an application built comprising a neural network requires a 3D tensor/matrix of data as input. The corresponding directive may be issued to the prepare stage. If the compiler sees an opportunity to make a buildable model to satisfy both this neural net application and the needs of the metadata taps applied, it may elect to move this transform to an earlier processing stage, or to inject another prepare stage before the store stage.

A constrained data paradigm 208 comprises a humanly-usable interface offering a set of high-level descriptions that define intended uses and goals to be achieved by processing data through the data digest system and providing it to consuming applications. The constrained data paradigm 208 remains equally accessible via machine-to-machine interfaces—thus providing an input means to control the data digest system's behaviour that is source-agnostic. The use of a constrained data paradigm 208 provides users with the means to use humanly-readable, end-user specific definitions of the desired data digest system behaviour, without the need to understand the detailed internal workings of the data source device, the data digest system itself, or the consuming application.

For example, a user needs to meet a requirement to supply data in usable format to a Microsoft® Excel™ application and to Vendor Z's Artificial Intelligence application from 1000 smart meter devices calibrated in SI units supplied by Vendor X and 50,000 light sensor devices calibrated in United States Customary units supplied by Vendor Y. The data from the devices is delivered every 90 seconds, must be correlated in SI units rounded downward for reconciliation, and historical data must be retained for 30 days. The data is to be shared with a third-party Company A in Excel format. The user's company policy permits the data digest service to extract and use metadata relating to its use of the data digest system so that the system may be optimized. The constrained data paradigm must therefore comprise means to define:

Ingest: data source definitions for Vendor X smart meter devices and Vendor Y light sensor devices.

Store: store both smart meter and light sensor data and retain for 30 days.

Prepare: convert light sensor data to SI units, populate Excel spreadsheet with both sets of data, prepare data in Vendor Z's Artificial Intelligence application input format.

Share: share data in Excel format with Company A.

Metadata: permit logging at all stages.

In an exemplary implementation of the present technology, data source and preparation definitions derived from the constrained data paradigm 208 are used to create the formal structure descriptor and its augmentation for use by the data digest model compiler to generate the compiled executable that will be used in the running data digest system. Other definitions derived from the constrained data paradigm are used to control other aspects of the data digest system, such as the storage of the data.

It will be immediately clear to one of skill in the art that the arrangement shown in FIG. 2a provides the building blocks for a data digest system in which compilable data models may be constructed to decouple the forms of data output to data analytics consumers or subscribers from the technicalities, limitations and constraints associated with the physical data sources. With the presently provided technology, real data sources are rendered as virtual data sources, thus opening up a range of possibilities not available in conventional linear data-source-to-data-consumer pipelines, in which data formats and contents are inflexibly connected throughout the processing pipeline.

Thus, for example, each ‘virtual device’ may be associated, as in conventional arrangements, with one physical IoT data source device—but, importantly, the present technology also provides for other arrangements, such as the association of multiple virtual devices with the same physical data source device (there may be, for example a real-time virtual device and a lower bandwidth, non-real-time-update virtual device, but both relating to the same physical data source). Each virtual device may also be operable to provide several different levels of, for example, data transmission quality-of-service, data rate, or precision of content all related to data sourced from that particular physical device. In such a case, one physical device may present itself in its various virtualized forms, each of which may have distinct characteristics.

Each virtual device may thus be configured using the present technology to provide a selectable variety of data from a single physical IoT device or to aggregate data from a plurality of physical devices. As an example of the first case, a single physical device with multiple sensors may be operable to transmit different items of data pertaining to the different sensors, and might thus be represented as a set of different virtual devices, each providing data from one sensor.

In the second exemplary case, a set of virtual devices may be operable to aggregate a combination of data from several different physical devices; for example, a group of sensor devices may be arranged to collect data in a specific geographical region, and to aggregate it into a regional virtual device representation that is operable to transmit a single data stream of data as if the stream originated at a single physical device. Such a region wide data stream from a virtual device might provide, for example, “city X temperature” by combining inputs from a group of physical devices and applying in-line statistics, machine intelligence or other computational techniques in addition to its normal data formatting and shaping.

Turning now to FIG. 3, there is shown an example of a computer-implemented method 300 according to the presently described data digest technology. The method 300 begins at START 302, and at 304 a set of constrained paradigms for structuring input, processing and output of data in the data digest system are established. At least one part of the set of constrained paradigms is directed to the control of input, internal and external data structures and formats in the data digest system. At 306, a data structure descriptor defining the structures of data available from a data source is received—this descriptor typically comprises data field names, data field lengths, data type definitions, data refresh rates, precision and frequency of measurements available, and the like. At 308, the data structure descriptor received at 306 is parsed, a process that typically involves recognition of the input descriptor elements and the insertion of syntactic and semantic markers to render the grammar of the descriptor visible to a subsequent processing component. At 310, the relevant constrained paradigm is identified (possibly by means of specific markers detected during parsing 308) and retrieved from storage to be applied 312 to the parsed data structure descriptor to generate a formal structure descriptor suitable for inclusion 314 in a compilable data model. If it is determined at test 316 that data content defined in the data structure descriptor will require transformation during the runtime operation of the data digest system, the formal structure descriptor is augmented at 318 and the augmentation is included in the compilable data model. Then, and also if no augmentation is required, test 320 determines (according to pre-established criteria) whether the compilable data model is suitable, either “as-is” or in modified form, for reuse. If so, the compilable data model is stored at 322. Then, and also if no reuse is contemplated, the compilable data model is input to the compiler at 324. The compiler generates a compiled executable 216 for data analysis from the compilable data model at 326 and the process completes at END step 328. The compiled executable 216 may then be operable during at least one of the ingest stage, the integrate stage, the store stage, the prepare stage, the discover stage and the share stage of an instance of operation of said data digest system.

Broadly, then, the various implementations of the present technology provide the building blocks for the construction of digests of data suitable for data analysis by multiple consumers or subscribers, with full independence from the technicalities of the data sources and communications channels used, and thus decouples source devices from the data they generate. In effect, the data sources are virtualized, freeing the provision of data for analysis from constraints and limitations associated with particular device types and with the means by which the data is accumulated and transmitted.

In one implementation of the present technology, the descriptor of the data structure is modifiable to enable the generation of at least one further descriptor of a data structure for data content that can be emitted by a second or further physical data source device. In this way, stored data structure descriptors may serve as a pool of models to save time in developing descriptors for future data structures that may be emitted, either by existing data source devices, or by newly-developed devices.

Turning now to FIG. 4, there is shown a further example of a computer-implemented method 400 that uses a compilable data model according to the presently described data digest technology. The method 400 begins at START 402, and at 404 a data stream is received from many data sources in a variety data types having differing specific data rates, data patterns, data formats and data shapes as described in relation to the data stream input 102. At 406, the data is transformed using a compilable data model to a pre-determined format that is agnostic to the variety of data types such as consumption pattern, rate or shape of the data. The data transformed to the pre-determined format is received and stored at 408 in the form of multiple canonical data formats provided by the compilable data model. The data at 408 is now stored in a neutral format that can in practice be communicated with any number of tools having the appropriate application software to retrieve and read the data. In 410 any one or more of the multiple canonical data formats are retrieved and in 412 applied to a value algorithm for data processing. In 412 the value algorithm transforms the data using the compilable data model to a form required by an endpoint, for example, in 414 the data may be transformed to a sparse matrix format, in 416 into a file format or in 418 into formats compatible with XML or JSON usage. At 420, data that has been transformed in the sparse matrix format is output as a data stream to an application for its use and analysis by the application at the endpoint at 422. For example, such a use may be in deep learning and machine learning. The process completes at END step 424.

Using the processes described above, the compiled data digest model can be interpreted by the data digest pipeline system by mapping its elements according to Application Programming Interface (API) constructs that are available. Mapping is thus a process of interpreting a compiled data digest model. Compiling a data digest model means it can be matched against the APIs and allowable modes for each data digest processing stage that may be applied.

A simple analogy is that the APIs act like CPU instructions and FIG. 2a 202, 208 like the program. Like all compilers the data digest compiler can reorder and optimize operations in order to best implement the intent of 202, 208 and any policy descriptors (for details of policy descriptors, see below) in the form of API calls. The mapping process is essentially taking this compiled form and interpreting it to stimulate the appropriate APIs to set up and run the data digest pipeline. The types of parameters and constraints provided as input are the descriptors for 202 and 208 and any policy inputs, and these need to be reconciled with what the APIs allow as a runtime implementation.

In one implementation, the present technology may be further provided with instrumentation operable during at least one of the parsing, restructuring, augmenting or inputting steps to generate a data set for subsequent analysis by the data digest system. The technology thus adapted achieves reflexivity, enabling machine-learning techniques to analyse the feedback to improve future operation of the data digest system. Thus, at any point in the data digest pipeline, behavioural data may be gathered and processed. For example, gathered data can be metadata related to the received input data or the receiving of the input data such as at 404A. Gathered data can be metadata related to the transformations applied to data stream at 406A. Gathered data can be metadata related to the value algorithm processing at 412A. Gathered data can be metadata related to the output data stream at 420A and consumption of the output data stream by the endpoint 422A.

FIG. 5 shows one example of a metadata digest pipeline according to presently described technology. At any stage of 404A, 406A, 412A, 420A and 422A including at stages not shown in FIG. 2a, a metadata stream input 502 may be input into a vertical data digest system 500. As described in relation to FIG. 1, the data digest system 500 comprises an ingest stage 504, a storage 506, an analysis, diagnostics and value stage 508 to generate digested information 510.

According to the presently described technology, foregoing techniques enable an IoT service or platform to track and rank data sources from available sensor data, based on multiple factors including nature of content, geography, data quality, reliability, demand and performance. According to present techniques, contributing ranking factors can be collected from the control plans of the devices themselves, the delivery networks and the data processing pipelines in the cloud. Indeed, virtually any data in the control plan can contribute to the tracking and ranking of data sources. Ranking data enables applications and users to select data sources based on historical patterns such as technical reliability, that is being able to take into account factors such as downtime, data size, security of data, age, trust and source of the data.

Ranking data may be a dynamic feature rather than a static feature. In present techniques, the relative ranking of data may change depending on the metrics specified as important by the application or user. Such a technique is beneficial to the flexibility of the service since different applications or users can have different technical requirements for their service such as age of data, update frequency, volume and so in this way ranking is context specific. Additional flexibility can be introduced into the service as raw factors and ranking data is supplied to the application or user to allow them to apply their own processing and algorithms to make their own determinations about the value and quality of the device data that is received.

An IoT service or platform may operate on raw data from devices or alternatively from virtualised data via decoupled data streams. Such decoupled data streams built upon the same raw data may carry different levels of data abstraction/content update frequency and may result in different rankings depending on the characteristics of the data required. Possible metrics include (without limitation):
Availability
Use by third parties, access frequency and consumption patterns;
Subscriber feedback which may be automated;
Reliability;
Integrity of data;
Level of trust placed on the data by the user or application;
Realtime/non-real time/update frequency;
Detail/accuracy
Data stream from a single source vs merged data stream from multiple sources;
Security level of the data stream.

As a route to improving the accuracy of the data, there may be provided an automatic data self-enrichment. The self-enrichment may employ usage attributes such as data usage, user identity, purpose of usage and number of users. In any data ranking system, a subset of data sources may become more trusted than other sources. Such more trusted sources of data may result in a tiered, hierarchical ordering of data which in turn may lead to the provision of a data “hall of fame” per category of data. Such an ordering of data can enable a new user to immediately access most relevant data for its purpose. Other embodiments for data self-enrichment include data criticality such as a measure of how important a data stream is to a set of consuming applications and a data “reputation” for specific topics automatically based on actual usage of data. Such improvement may provide a self-review or other automated review and ranking framework for the data, which subsequently may lead to value based exchange of data or other abstract services that exchange data governed by measures of value or utility.

In further embodiments, automated feedback to an operator/sensors provider/cloud provider may also be provided to identify better or weaker rated devices and data sources to allow a provider to choose whether to improve, categorise or prioritise access to higher ranking devices; or modify characteristics such as increasing/decreasing notifications, propose backups and alternatives. Accordingly, in FIG. 6 a data sharing platform 600 comprises both a raw data sourcing platform 602 and a decoupled data sourcing platform 604, each in electronic communication over a network that also comprises a data digest system 601 according to the presently disclosed technology. Raw data sourcing platform 602 comprises many hundreds, indeed thousands of customer IoT devices 606 connected to a network 608. Substantial data flow 610 occurs across the network 608 and data metrics may be assessed at data flow module 612. Such data metrics assessed at the data flow module 612 include data flow duration and flow volume in both packets and bytes. Various granularity of data flow may be analysed including destination network and host pair. Data metrics gathered at data flow module 612 may be communicated to a value based data exchange module 614.

Data port 616 may provide a metadata analysis according to present techniques including for the tracking and ranking of data sources from available sensor data, based on multiple factors including nature of content, geography, data quality, reliability, demand and performance for use in user or application consumption 618.

Decoupled data sourcing platform 604 comprises an IoT platform 620 having ownership by a specific entity A. Entity A in the present embodiment allows sharing of its IoT devices across network 622. Substantial data flow 624 occurs across the network 622 and data metrics may be assessed at a data flow module 626. Such data metrics assessed at the data flow module 626 include data flow duration and flow volume in both packets and bytes. Various granularity of data flow may be analysed including destination network and host pair. Data metrics gathered at data flow module 626 may be communicated to a value based data exchange module 628. Also in the present embodiment, a virtual device port 629 enables data sharing between multiple virtual devices 630. Such data sharing may provide further metrics to the data flow module 626 to adjust any output of the value based data exchange module 628.

Examples of metadata analysis providing value-add for a user or application include:

estimating the criticality of data when used in a system to determine whether to keep the source of data or to get more of that type of device data;

to assess risk or vulnerability of a device data system by assigning value metrics to the sources of data;

to apply an integrity or trust value to the data in setting where a user or application may want to share the data with a 3^{rd} party such as for data trading or value;

to apply a use case or industry specific value/score to the data when sharing data between 3^{rd} parties;

in a future machine to machine negotiation for access to data, applying integrity or trust value criteria that is derived from the consuming machines analytic needs.

In the examples there are many alternative sources of data that can be compared to each other, and the comparisons can be done via applications that calculate utility and that are attached to the metadata layers of data digest. Attached applications that make comparisons will have to have visibility into systems of systems of devices or systems of systems of systems of devices.

Some examples of how to calculate utility in data include:
criticality of data (for example, in an energy distribution system)
   all energy flow sensors across an energy system feed data into at least 1 consuming application (as captured in data digest metadata);
   a subset Y of energy flow sensors at the core of the energy grid contribute to every consuming application in the enterprise/operation;
   a subset of Y, subset Z, also is shared out to 3^{rd} party maintenance and security applications outside of the enterprise/operation;
   by applying a simple function of #-of-consuming-apps & #-of-3^{rd} party-consumers, Y could be scored as the most critical devices in the system and warrant extra care and attention and security;
   the critical devices are those devices having the highest value or utility in the system from a criticality perspective.
Risk/vulnerability (for example, in a fleet of automotive vehicles)
   all sensors or device streams in a fleet can be scored against a security ranking by polling any security information pertaining to TLS and storage encryption (as captured in data digest metadata);
   all streams can have stability scores based on data delivery regularity or deviations from norms (# of anomalies) calculated from the metadata set;
   a function of stability and level of security can be used to score which devices appear unstable and vulnerable and hence pose a risk to the safety of a vehicle;
   . . . these devices have the highest utility or value in a safety or security audit scenario.
Utility value—for example, an engineer wants to study temperature data (e.g. temperature in Cambridge Science Park) in their system and wants to obtain data from an IoT platform provider.
   The provider has n sources of temperature data ranked and scored by a function of #-of-consuming apps, level of security, reliability of delivery of data, lifetime volume of data delivered, number of existing 3^{rd} party sharing relationships, number of anomalies etc . . . (all signals present in the data digest metadata layer);
   . . . the ranking and scores are a use case specific descriptor of which source of data is worse of best or in between in terms of trust and integrity;
   The person can make a request to access the trusted data.
A Machine to Machine negotiation for data scenario includes finding data sources that meet some predetermined criteria such as a secure source of temperature data that has been consumed by 10 other analytics applications. Or, as a value function of all of the critical, risk, vulnerability and utility values provided.

Turning now to FIG. 7, there is shown a method 700 of harvesting, generating or otherwise generally providing data according to a ranking. The method begins at 702 and at 704 a data digest system as described herein provides an analytical representation such as a metadata representation of various data entities, sources and network relationships in a network.

At 706 a rule schema for ranking the data is established by some predetermined means accessible and adjustable by users depending on various factors. The rule schema may be created and manipulated by a called application. At 708, the rule schema is stored for use on demand at some point in the IoT platform or data digest system. According to present techniques, at some point a request 710 is made from a data consumer to request data with some conditions applied which conditions are aided through providing and analyzing the data ranking. At 710 the request is received at the data digest entity and at least a segment of a data stream comprising at least one said data entity from at least one ranked data source is received. At 712 a rule engine, which may be a called application, is run to apply the stored rule schemas against the segment of data by linking associated ranking metadata with the segment of data. Responsive to the associated ranking metadata at 714 matching the requested ranking metadata, the method populates an output data structure from data in the data segment by the data digest and at 716 the populated data structure is communicated to the data consumer in a manner determined by the data digest configuration. The method ends at 718.

In addition to the constraints and requirements imposed by the available inputs, internal dependencies, processing constraints and consumer application needs, higher-level controls may need to be applied to data digest pipelines, and this can be achieved using policies, that is, rules on what can happen to data or limits on what can be done. In one example, a policy may say that a certain user is only authorized to access the average of data or some aggregate thereof. So, for example, personally identifiable data in health-related records may need to be protected from exposure, and this can be controlled by means of an appropriate policy. In another example, a consuming application may be restricted so that it will only consume 2 Gbytes of data. In a further example, there may be a requirement that stored data cannot be deleted or modified for 31 days to satisfy a legal requirement. These and other policies can be applied to the creation of a compiled executable (216) by taking a policy descriptor as an input as shown in FIG. 2c. In one implementation, compiled data models may also be exported and checked against policies by a third-party application. The application of policies need not be restricted to main data flow pipelines, but may also be applied to metadata, and thus metadata for FDP, SDP′ SDP″+++ descriptions of the system as described above can be also checked against policies at the next level up.

In every stage of, or operation permissible in, a data digest pipeline—a policy enforcement point can be inserted that gates the operation with a yes/no option to execute if the policy says so. The configuration of these policy enforcement points can be configured at the mapping stage of creating a pipeline or under the control of the consuming application (if, for example, a different user with different data access rights logs in to the consuming application).

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

Accordingly, as described herein techniques may provide a machine-implemented method including pre-processing of the gathered behavioural data to create one or more hierarchical output data streams, each in a respective canonical format and outputting the formatted hierarchical output data stream to any data driven application and analytic platform; and thereby gathering hierarchical behavioural data relating to the gathered behavioural data. In embodiments, the method may include repeating pre-processing of hierarchical behavioural data. The method may include extracting metadata from the behavioural data related to the at least one of the received input data, the receiving of the input data, the transformations applied to the input data, pre-processing of the transformed data, the output data streams, and the consumption of the output data streams. In embodiments, said data stream pipeline is formed in a data digest system configuration block comprising data structures and processing directives for at least one of an ingest stage, a store stage, an integrate stage, a prepare stage, a discover stage and a share stage of said data digest system. Preferably, generating the signal includes determining data usage analytics. In embodiments, the method may include converting the metadata into sets of technical parameters and constraints and configuring the data stream pipeline ready for runtime treatment of data streams received from the multiple sources of input data. In such an embodiment, the metadata may form the basis for any algorithm that has a canonical relationship with the output data streams. In some cases, the method includes harvesting multiple sources of input data from multiple interconnected devices and the input data may be representative of at least one of data usage, power, on-off time and memory constraints. In embodiments, the method may include gathering behavioural data related to past event gathered behavioural data.

In a further technique, an electronic apparatus is provided for data processing in a data stream pipeline, wherein the data stream pipeline is formed from multiple sources of input data.

It will be clear to one skilled in the art that many improvements and modifications can be made to the foregoing exemplary embodiments without departing from the scope of the present technique.

1. A machine implemented method of data processing in a data stream pipeline formed from multiple sources of input data, the method comprising:
receiving input data from multiple sources, the data having differing format and data rates;
buffering the data and transforming the data to a predetermined format;
pre-processing the transformed data to create one or more output data streams, each in a respective canonical format;
outputting the formatted output data stream to any data driven application and analytic platform; and
gathering behavioural data relating to at least one of: received input data, the receiving of the input data, the transformations applied to the input data, pre-processing of the transformed data, the output data streams, and the consumption of the output data streams; and
using the gathered behavioural data to generate a signal.

2. The machine-implemented method according to claim 1, further comprising:
pre-processing the gathered behavioural data to create one or more hierarchical output data streams, each in a respective canonical format; and
outputting the formatted hierarchical output data stream to any data driven application and analytic platform,
where said outputting the formatted hierarchical output data stream gathers hierarchical behavioural data relating to the gathered behavioural data.

3. The machine-implemented method according to claim, further comprising repeating pre-processing of hierarchical behavioural data.

4. The machine-implemented method according to claim 1, further comprising extracting metadata from the behavioural data related to said at least one of the received input data, the receiving of the input data, the transformations applied to the input data, pre-processing of the transformed data, the output data streams, and the consumption of the output data streams.

5. The machine-implemented method according to claim 1, wherein said data stream pipeline is formed in a data digest system configuration block comprising data structures and processing directives for at least one of an ingest stage, a store stage, an integrate stage, a prepare stage, a discover stage and a share stage of said data digest system.

6. The machine-implemented method according to claim 1, wherein generating the signal includes determining data usage analytics.

7. The machine-implemented method according to claim 4, further comprising converting the metadata into sets of technical parameters and constraints and configuring the data stream pipeline ready for runtime treatment of data streams received from the multiple sources of input data.

8. The machine-implemented method according to claim 4, wherein the metadata forms the basis for any algorithm that has a canonical relationship with the output data streams.

9. The machine-implemented method according to claim 1, further comprising harvesting multiple sources of input data from multiple interconnected devices.

10. The machine-implemented method according to claim 1, wherein the input data is representative of at least one of data usage, power, on-off time and memory constraints.

11. The machine-implemented method according to claim 1, further comprising gathering behavioural data related to past event gathered behavioural data.

12. An electronic apparatus for data processing in a data stream pipeline formed from multiple sources of input data, the apparatus comprising:
receiver logic operable to input data from multiple sources, the data having differing format and data rates;
buffer logic operable to buffer the data and transform the data to a predetermined format;
pre-processing logic to pre-process the transformed data to create one or more output data streams, each in a respective canonical format;
output logic to output the formatted output data stream to any data driven application and analytic platform;
gathering logic to gather behavioural data relating to at least one of: received input data, the receiving of the input data, the transformations applied to the input data, pre-processing of the transformed data, the output data streams, and the consumption of the output data streams; and
signal generating logic operable to use the gathered behavioural data to generate a signal.

13. The apparatus as claimed in claim 12, further comprising:
additional pre-processing logic operable to gather behavioural data to create one or more hierarchical output data streams, each in a respective canonical format; and
further output logic operable to output the formatted hierarchical output data stream to any data driven application and analytic platform,
where said output the formatted hierarchical output data stream gathers hierarchical behavioural data relating to the gathered behavioural data.

14. The apparatus as claimed in claim 12, further comprising extracting logic operable to extract metadata from the behavioural data related to said at least one of the received input data, the receiving of the input data, the transformations applied to the input data, pre-processing of the transformed data, the output data streams, and the consumption of the output data streams.

15. The apparatus as claimed in claim 12, wherein said data stream pipeline is formed in a data digest system configuration block comprising data structures and processing directives for at least one of an ingest stage, a store stage, an integrate stage, a prepare stage, a discover stage and a share stage of said data digest system.

16. The apparatus as claimed in claim 12, wherein generating the signal includes determining data usage analytics.

17. The apparatus as claimed in claim 16, further comprising converting logic operable to convert the metadata into sets of technical parameters and constraints and configure the data stream pipeline ready for runtime treatment of data streams received from the multiple sources of input data.

18. The apparatus as claimed in claim 12, wherein the multiple sources of input data are fed from multiple interconnected devices.

19. The apparatus as claimed in claim 18, wherein the input data is representative of at least one of data usage, power, on-off time and memory constraints.

20. A computer program product comprising a computer-readable storage medium storing computer program code operable, when loaded into a computer and executed thereon, to cause said computer to carry out a method of data processing in a data stream pipeline formed from multiple sources of input data, the method comprising:
receiving input data from multiple sources, the data having differing format and data rates;
buffering the data and transforming the data to a predetermined format;
pre-processing the transformed data to create one or more output data streams, each in a respective canonical format;
outputting the formatted output data stream to any data driven application and analytic platform;
gathering behavioural data relating to at least one of: received input data, the receiving of the input data, the transformations applied to the input data, pre-processing of the transformed data, the output data streams, and the consumption of the output data streams; and
using the gathered behavioural data to generate a signal.
